(19) United States
(12) Patent Application Publication
(10) Pub. No.: US 2026/0273605 A1
(43) Pub. Date: Sep. 17, 2026

(54) INFORMATION PROCESSOR, PRESS MACHINE SYSTEM, AND DATA GENERATION METHOD

(71) Applicant: Murata Machinery, Ltd., Kyoto-shi, Kyoto (JP)

(72) Inventor: Yuuya HAGINO, Kyoto-shi (JP)

(21) Appl. No.: 19/167,962

(22) PCT Filed: Feb. 22, 2024
(86) PCT No.: PCT/JP2024/006497

§ 371 Date: Sep. 23, 2025

(30) Foreign Application Priority Data
Apr. 7, 2023 (JP) 2023-062828

(51) Int. Cl. B21D 11/02; G06T 19/20

(52) U.S. Cl. CPC B21D 11/02; G06T 19/20; G06T 2200/24; G06T 2210/62; G06T 2219/2016

(57) ABSTRACT

An information processor, is configured or programmed to create a shape model to display an image to assist with an operator's operation on a display of a press machine that is capable of machining a workpiece W. The information processor is configured or programmed to include a data generator configured or programmed to generate the shape model used in machining the workpiece, an input interface configured or programmed to accept input of a display attribute of the shape model, and a setter configured or programmed to set the display attribute to display the shape model on the display to the display attribute accepted by the input interface.

### BACKGROUND OF THE INVENTION

### 1. Field of the Invention The present invention relates to information processors, press machine systems, and data generation methods.

### 2. Description of the Related Art

A press machine clamps a workpiece between an upper die and a lower die to perform press machining such as mold machining on the workpiece. As one type of press machine, a press brake (bending machine) that performs bending on a plate-shaped workpiece is known. In such a press brake, the operator arranges a workpiece at a predetermined position and drives the upper die or the lower die to perform bending by clamping the workpiece between the upper die and the lower die. In each step of bending a workpiece, the operator confirms the direction in which the workpiece is brought into contact with the back gauges, using operation instructions or design drawings related to the workpiece. To assist the operator with these types of confirmation tasks, a technique has been proposed that displays an image of a correctly oriented workpiece for each step on a display of the press brake, allowing the operator to confirm the direction in which the workpiece is brought into contact with the back gauges by viewing the image (for example, see Japanese Unexamined Patent Application, First Publication No. 2019-42766).

### SUMMARY OF THE INVENTION

The display attribute of a workpiece shown on the display remains constant across all steps. Therefore, even when confirming the workpiece displayed on the display in a particular step, there may be instances where the section requiring attention during workpiece placement is difficult to see and confirm. As a result, depending on the step, even if the operator looks at the image displayed on the display, there is a possibility that the section requiring attention will be overlooked, and the workpiece may be placed in the press machine in an incorrect orientation. Therefore, the operator is required to carefully observe the image displayed on the display and find the section that requires attention. However, this task is time-consuming and significantly increases the burden of the operator.

Example embodiments of the present invention provide information processors, press machine systems, and data generation methods that each reduce the burden of an operator.

An information processor according to an example embodiment of the present invention is an information processor configured or programmed to create a shape model to display an image to assist with an operator's operation on a display of a press machine that machines a workpiece. The information processor is configured or programmed to include a data generator configured or programmed to generate the shape model used in machining the workpiece, an input interface configured or programmed to accept input of a display attribute of the shape model, and a setter configured or programmed to set the display attribute of the shape model to display the shape model on the display to the display attribute accepted by the input interface.

A press machine system according to an example embodiment of the present invention includes the information processor according to an example embodiment of the present invention, and a press machine to machine a workpiece by clamping the workpiece between an upper die and a lower die, wherein the press machine includes a main body to hold one of the upper die and the lower die, a display provided on the main body or provided separately from the main body, and a controller configured or programmed to display the shape model on the display using the display attribute set by the setter.

A data generation method according to an example embodiment of the present invention is a data generation method of an information processor to create a shape model to display an image to assist with an operation of an operator on a display of a press machine to machine a workpiece. The data generation method includes generating the shape model used in machining the workpiece, accepting input of a display attribute of the shape model, and setting the display attribute of the shape model to display the shape model on the display to the display attribute accepted by the input interface.

According to the information processor or the data generation method according to the above example embodiments, it is possible to set the display attribute of a shape model so as to make it easier to confirm the section that requires attention during the bending operation. As a result, the operator can passively recognize the section that requires attention, which contributes to reducing the burden of the operator. In the information processor of the above example embodiments, the setter may be configured or programmed to set a different display attribute in each of the steps. According to such a configuration, the operator can perform a bending operation in each step while confirming the image corresponding to the step.

In the information processor of the above example embodiments, the display attribute may be at least one of a display angle, a display magnification, or a transmittance. According to such a configuration, the operator can passively recognize the section that requires attention, which contributes to reducing the burden of the operator.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a diagram showing an example of a press machine system according to the present example embodiment.

FIG. 2 ' is a side view showing an example of a press machine according to the present example embodiment.

FIG. 3 is a front elevation view of the press machine shown in FIG. 2.

FIG. 4 is a diagram showing an example of an image projected by a projector according to the present example embodiment.

FIG. 5 is a diagram showing an example of function blocks of the press machine according to the present example embodiment.

FIG. 6 is a diagram showing an example of a hardware configuration of an information processor according to the present example embodiment.

FIG. 7 is a functional block diagram of a processor according to the present example embodiment.

FIG. 8 is a diagram showing an example of step assist data according to the present example embodiment.

FIG. 9 is a diagram showing an example of a shape model prior to a change in the display angle according to the present example embodiment.

FIG. 10 is a functional block diagram of a processor according to the present example embodiment.

FIG. 11 is a diagram showing an example of a shape model prior to a change in the display angle according to the present example embodiment.

FIG. 12 is a diagram for describing a workpiece arranged in a correct orientation according to the present example embodiment.

FIG. 13 is a diagram for describing a workpiece arranged in a correct orientation according to the present example embodiment.

FIG. 14 is a diagram showing an example of a shape model after a change in the display angle according to the present example embodiment.

### DETAILED DESCRIPTION OF THE EXAMPLE EMBODIMENTS

Hereinafter, example embodiments of the present invention will be described. However, the invention defined in the claims is not limited to the following example embodiment, and not all combinations of features described in the example embodiments are essential. £ In the drawings, the same or similar structural elements are denoted by the same reference signs, and redundant descriptions may be omitted. The shape and size of the elements in the drawings may be exaggerated for the purpose of clearer description.

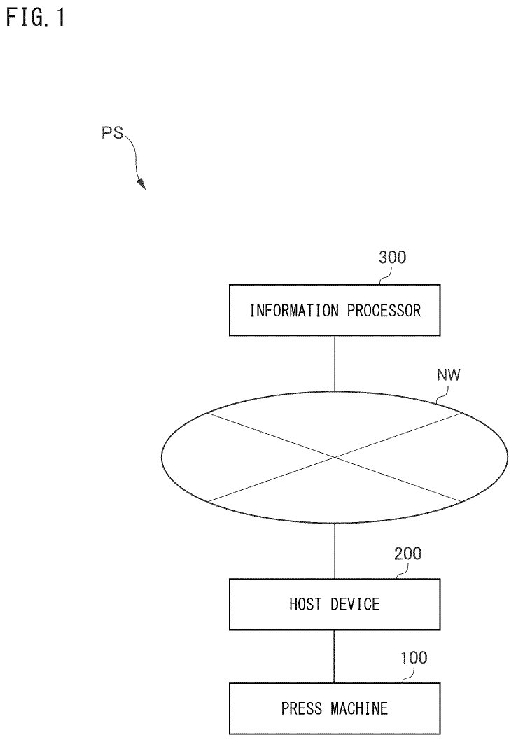

FIG. 1 is a diagram showing an example of a press machine system RS according to the present example embodiment. The press machine system RS includes a press machine 100, a host device 200, and an information processor 300.

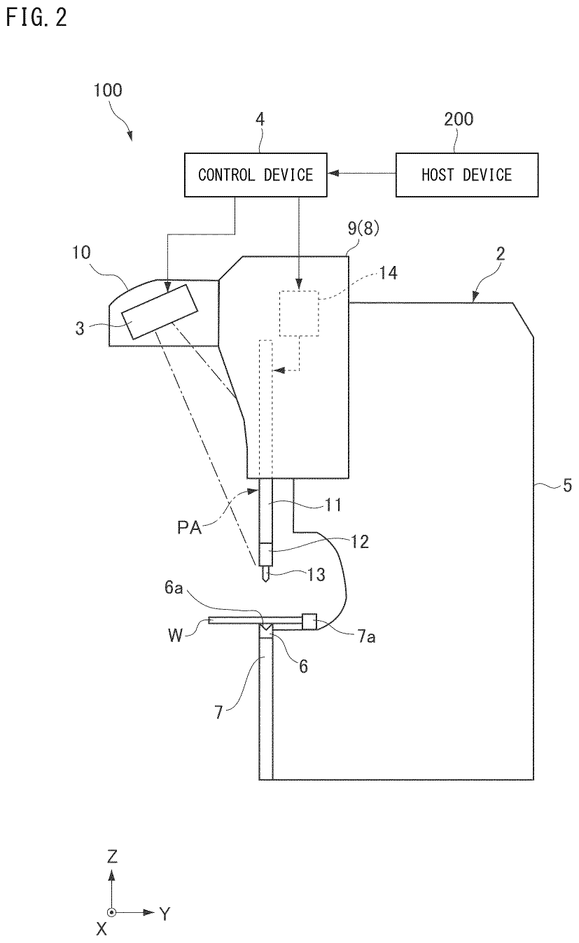

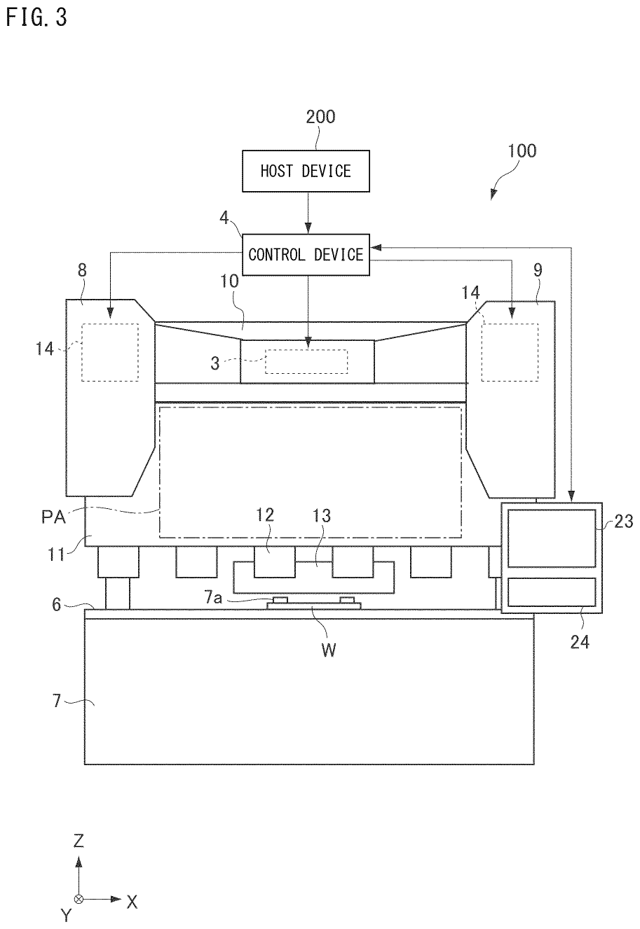

FIG. 2 is a side view showing an example of the press machine 100 according to the present example embodiment. FIG. 3 is a front elevation view of the press machine 100 shown in FIG. 2. The press machine 100 is, for example, a press brake capable of performing bending on a workpiece W. Hereinafter, in the present example embodiment, the press machine 100 is described as an example of a press brake, but example embodiments of the present invention are not limited to a press brake. For example, the press machine 100 may be a machine (for example, a turret punch press) equipped with a tool (for example, a die) capable of performing press-cutting (punch machining) or mold machining on a workpiece W.

As shown in FIG. 2 and FIG. 3, the press machine 100 includes a main body 2, a projector 3, a control device 4, a display 23, and an operation panel 24. The main body 2 has a working space for an operator OP on the front side. The operator OP places a workpiece W at a predetermined position from the front side, and can perform bending on the workpiece W by clamping the workpiece W between an upper die 13 and a lower die 6, which will be described later. The main body 2 includes, for example, a main body frame 5, a table 7, side frames 8, 9, a cover 10, and a ram 11.

The main body frame 5 defines an outer framework of the press machine 100. The lower die 6 is a fixed-side (lower side) die supported on the upper surface of the table 7 and is formed along the left-right direction (X direction). The lower die 6, on the upper surface side thereof, has a V-shaped recess 6a to bend a workpiece W. The recess 6a extends along the left-right direction. The table 7 is attached to the front side (front-facing side) of the main body frame 5 and fixes the lower die 6. The table 7 is provided with back gauges 7a that position the workpiece W by bringing it into contact therewith in the +Y direction. The back gauges 7a may be provided independently of the main body frame 5.

The side frames 8, 9 are each attached to the upper left and right sides of the main body frame 5. The side frames 8, 9 are arranged so as to cover the upper left and right sides of the ram 11, respectively. The side frames 8, 9 each accommodate a driver 14. Each driver 14 is supported on the main body 2 by a support frame or the like not shown in the drawings. The drivers 14 move (raise and lower) the ram 11 in the Z direction. The drivers 14 may include, for example, a mechanism that raises and lowers the ram 11 by rotating a ball screw or a nut with an electric motor or the like, or a mechanism that raises and lowers the ram 11 using a hydraulic cylinder device or a pneumatic cylinder device.

The cover 10 is arranged between the side frames 8, 9 in the left-right direction (X direction). The cover 10 is arranged above and in front of the ram 11, at the upper portion of the main body frame 5. The cover 10 includes a section that projects forward (in the −Y direction) relative to the ram 11. The cover 10 accommodates the projector 3, which will be described later, in this projecting section.

The ram 11 is supported on the main body 2 by a guide provided on the main body frame 5 so as to be able to ascend and descend. The ram 11 is a plate-shaped structure made of, for example, from metal or a comparable material. The ram 11 is connected to a portion of the drivers 14 and arranged in a state of being suspended by the drivers 14. The ram 11 is raised or lowered by driving the drivers 14 and approaches or moves away from the lower die 6 on the table 7.

Multiple upper die holders 12 are attached to the lower side of the ram 11. The multiple upper die holders 12 are arranged along the left-right direction (X direction). The spacing between adjacent upper die holders 12 can be arbitrarily adjusted. Each upper die holder 12 may be provided, for example, to be movable in the left-right direction with respect to the ram 11, so that the spacing between the upper die holders 12 can be changed. The upper die holders 12 are provided so as to be attachable to and detachable from the ram 11. Each of the upper die holders 12 is capable of holding an upper die 13. For example, when bending a workpiece W, the upper die holders 12 hold the upper die 13 corresponding to each step of the bending.

When the upper die 13 is held by the upper die holders 12, its lower end extends along the left-right direction, opposing the recess 6a of the lower die 6. The lower end of the upper die 13 includes a distal end configured to enter the recess 6a of the lower die 6. The upper die 13 ascends and descends integrally with the ram 11 and the upper die holders 12. In the press machine 100, the upper die 13 moves toward the lower die 6 as the ram 11 moves, and the workpiece W is clamped between the upper die 13 and the lower die 6. Bending is then performed on the workpiece W until the upper die 13 has reached the lowest point.

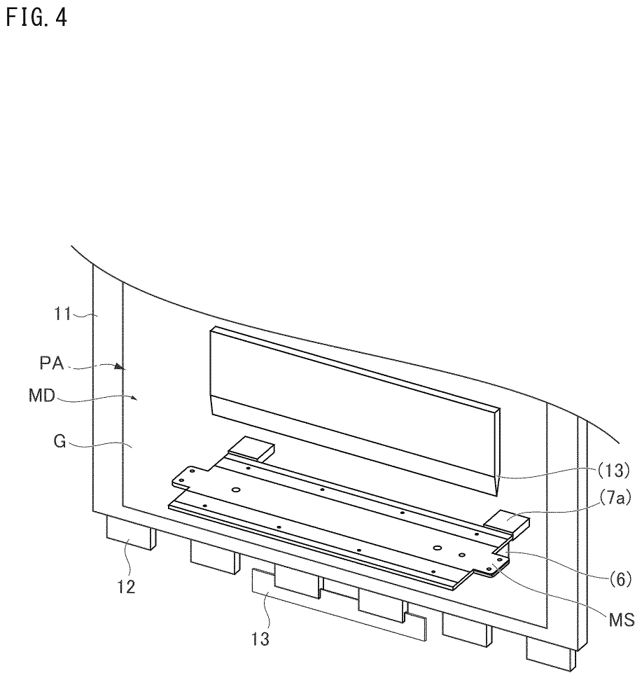

The projector 3 is provided on the main body 2 and projects an image G, to assist the operator OP in bending operations, onto a projection area PA including at least a portion of the ram 11. FIG. 4 is a diagram showing an example of an image G projected by the projector 3. The image G may be a still image or a video image. During the bending operation step, the operator OP arranges the workpiece W by bringing it into contact with the back gauges 7a and performs bending on the workpiece W by clamping it between the upper die 13 and the lower die 6.

Here, in those cases where the bending operation involves multiple steps, the orientation for arranging the workpiece W may vary for each step. In other words, the orientation in which the workpiece is brought into contact with the back gauges 7a may vary for each step. For example, when bending a single plate-shaped workpiece W into a box shape, four bending steps are required, and the operator OP needs to clamp the workpiece W between the upper die 13 and the lower die 6 while changing the orientation of the workpiece W for bringing it into contact with the back gauges 7a (hereinafter, may be simply referred to as “the orientation of the workpiece W”). That is to say, the operator OP needs to perform the bending operation while determining the orientation of the workpiece for bringing it into contact with the back gauges 7a in each step. Accordingly, the projector 3 displays the image G for each step that indicates the orientation of the workpiece W designated for that step, thus assisting the operator OP in performing this operation. The orientation of the workpiece W refers to either or both the direction in which the workpiece W is brought into contact with the back gauges 7a and the front/back orientation of the workpiece W.

The image G has a shape model MD usable to machine the workpiece W. In each step, the operator OP can readily visualize the correct arrangement of the workpiece W for actual machining by confirming the image G displayed on the display of the press machine 100 (for example, the projection area PA). This shape model MD is a two-dimensional or three-dimensional model. The shape model MD includes, for example, a shape model MS of the workpiece W in a state of being in contact with the back gauges 7a in a preset orientation. The shape model MD may further include two-dimensional or three-dimensional shape models of the back gauges 7a, the upper die 13, and the lower die 6, as exemplified in FIG. 4. The data to display the image G on the display is generated in advance by the information processor 300.

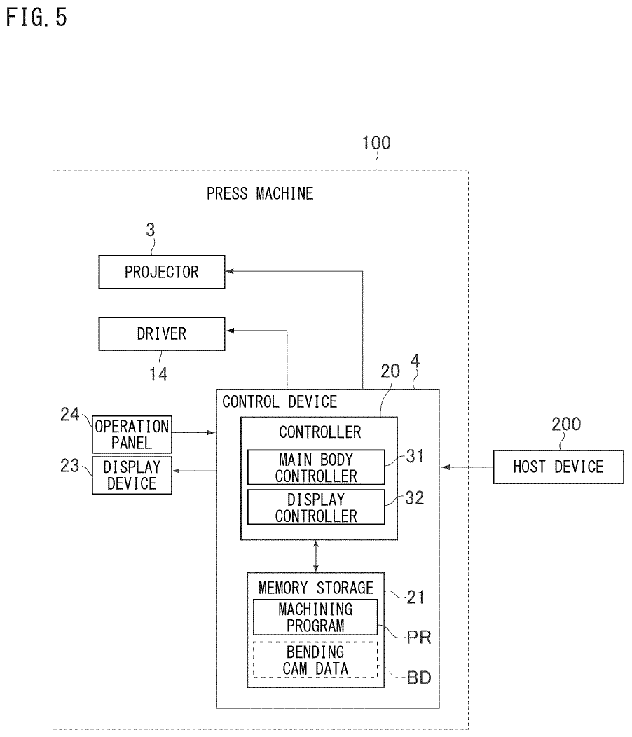

The control device 4 is configured or programmed to comprehensively control the operation of the main body 2. FIG. 5 is a diagram showing an example of function blocks of the press machine 100. As shown in FIG. 5, the control device 4 includes a controller 20 and a memory storage 21. The controller 20 is, for example, a hardware processor such as a CPU (Central Processing Unit). The controller 20 is configured or programmed to include, for example, a main body controller 31 and a display controller 32. The controller 20 reads out a machining program PR and so forth stored in the memory storage 21 and controls the operations of the drivers 14 and the projector 3. The memory storage 21 can either be provided within the main body 2 or be provided externally and connected to the control device 4 via a wired or wireless connection.

The memory storage 21 is, for example, a large-capacity memory storage device such as a hard disk, a non-volatile memory such as a USB memory or a flash memory or recording medium such as a CD. The memory storage 21 stores the machining program PR. The machining program PR is a program (machining data) that defines the operation of the main body 2 for each step. For example, the machining program PR defines the order of bending steps, information on the upper die 13 to be used in each step (for example, type, ID, and position), and the ram 11's movement conditions in each step (for example, start position, speed, and end position).

The main body controller 31 is configured or programmed to control the drivers 14 according to instructions from the operator OP and the machining program. For example, the main body controller 31 receives a signal from an operation pedal or an operation lever not shown in the drawings operated by the operator OP and controls the drivers 14 to start operating. The main body controller 31 is configured or programmed to control the display 23 to display various information such as the operating status and operating conditions of the main body 2, and the machining conditions of the workpiece W, for example. The operator OP can input information such as the settings of the main body 2, the material of the workpiece W, and machining conditions to the control device 4 through the operation panel 24. The control device 4 is connected to the host device 200 via a wired or wireless connection. The host device 200 supplies to the controller 3 bending CAM data BD including data to display the image G. The bending CAM data BD may further include position information of the back gauges 7a in each step. The bending CAM data BD supplied from the host device 200 is stored in the memory storage 21.

As shown in FIG. 3, the display 23 and the operation panel 24 are provided on the front side of the main body 2, and are arranged at a height that allows visual confirmation and operation performed by the operator OP. The display 23 is, for example, a direct-view type liquid crystal display. The display 23 is capable of displaying the image G described above. The display of the press machine 100 in the present example embodiment may be provided in the main body 2 or may be provided separately from the main body 2. The installation location of the display of the press machine 100 is not particularly limited. For example, it may be the projection area PA of the ram 11, or it may be the display 23 installed separately from the main body 2, or it may be both. The operation panel 24 is a keyboard, a mouse, a touch panel provided on the display 23, or the like. In such a case, the operation panel 24 is provided integrally with the display 23. The touch panel provided on the display 23 may also include a keyboard or the like. The display 23 may be arranged on the ram 11.

The display controller 32 is configured or programmed to control the operation of the projector 3. For example, on the basis of the bending CAM data BD, the display controller 32 is configured or programmed to control the projector 3 to project the image G that assists with the bending being performed on the workpiece at each step. The display controller 32 is configured or programmed to control the operation of the display 23. The display controller 32 may cause the display 23 to display the image G in each step of the bending of the workpiece W on the basis of the bending CAM data BD.

Next, the information processor 300 according to the present example embodiment will be described. The information processor 300 is configured or programmed to create bending CAM data BD before performing bending with the press machine 100. The information processor 300 is, for example, a computer having a CAM (Computer-aided manufacturing) functionality, which is software for generating bending CAM data BD. The information processor 300 is connected to a communication network NW, and transmits bending CAM data BD to the host device 200 via the communication network NW. The host device 200 transmits the bending CAM data BD to the press machine 100. The information processor 300 may transmit the bending CAM data BD to the press machine 100 via the communication network NW, without routing it through the host device 200. For example, the information processor 300 is arranged in a location different from where the press machine 100 is installed. The communication network NW may be wired, wireless, or a combination of both.

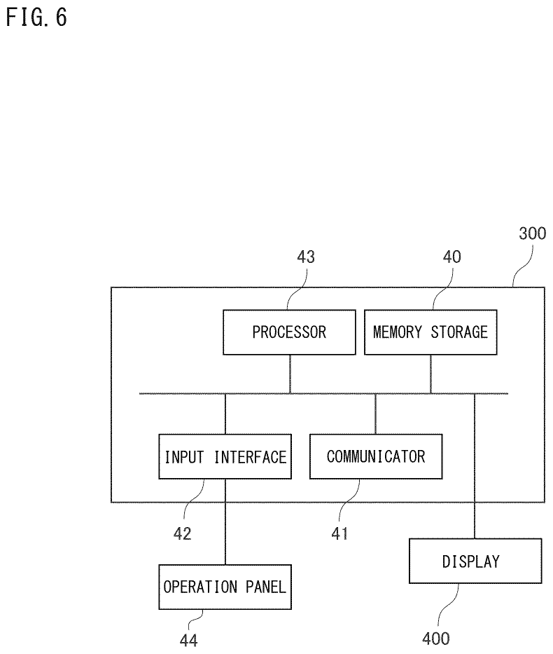

FIG. 6 is a diagram showing an example of a hardware configuration of the information processor 300 according to the present example embodiment. As shown in FIG. 6, the information processor 300 includes a memory storage 40, a communicator 41, an input interface 42, and a processor 43. The memory storage 40 may be an external memory storage, rather than being portion of the configuration of the information processor 300. In the case where the memory storage 40 is an external memory storage, the information processor 300 is connected to the memory storage 40 via wired or wireless communication and transmits and receives information to and from the memory storage 40.

The memory storage 40 stores, for example, a program (CAM software) executable to perform the process of creating bending CAM data BD, along with data processed by this program. Examples of the memory storage 40 include non-volatile memory, such as ROM (Read Only Memory), HDD (Hard Disk Drive), and SSD (Solid State Drive). The program mentioned above may be provided by a computer-readable storage medium or may be provided from an external device via a wired or wireless communication network. The provided program is stored in the memory storage 40 and executed by the processor 43. The memory storage 40 stores step information, including information related to the shape of the workpiece W to be bent in each step (for example, CAD data), the contents of each step of the bending operation, and the order of the steps.

The communicator 41 is a communication interface to communicating with external devices. The communicator 41 communicates with the host device 200 via the communication network NW.

The input interface 42 accepts input from a user. For example, upon accepting a user input from an operation panel 44, the input interface 42 transmits information corresponding to the accepted input to the processor 43 or the memory storage 40. Examples of the operation panel 44 include pointing devices such as a touch panel, touchpad, or mouse, buttons, switches, motion-sensitive controllers, keyboards, mice, gesture input devices, and voice input devices (for example, a microphone). The input interface 42 is connected to the operation panel 44, and when the operation panel 44 is operated by the user, the input interface 42 accepts input of information corresponding to the operation.

The processor 43 executes the process of creating bending CAM data BD. The processor 43 executes the program stored in the memory storage 40 and is capable of performing operations described by the program, that is, the processes related to the creation of bending CAM data. As an example, the processor 43 includes at least one of a CPU (Central Processing Unit), a MPU (Microprocessing Unit), or a GPU (Graphics Processing Unit).

The above program may be provided on a non-transitory computer-readable storage medium. The program is read from the non-transitory computer-readable storage medium, installed in the memory storage 40, and then executed by the processor 43. The above program may be downloaded from an external device through the communication network NW.

Examples of the non-transitory computer-readable storage medium may include electronic storage media, magnetic storage media, optical storage media, electromagnetic storage media, and semiconductor storage media. More specific examples of the non-transitory computer-readable storage medium may include diskettes, hard disks, random access memories (RAM), read-only memories (ROM), erasable programmable read-only memories (EPROM or flash memory), electrically erasable programmable read-only memories (EEPROM), static random access memories (SRAM), compact disc read-only memories (CD-ROM), digital versatile discs (DVD), Blu-ray (RTM) discs, memory sticks, and integrated circuit cards.

The information processor 300 is connected to a display 400. The display 400 displays various information. For example, the display 400 is a monitor for a personal computer. However, the display 400 is not limited to this example, and may be a display (display) of portable devices such as mobile phones, smartphones, and tablet terminals. The information processor 300 may include the display 400.

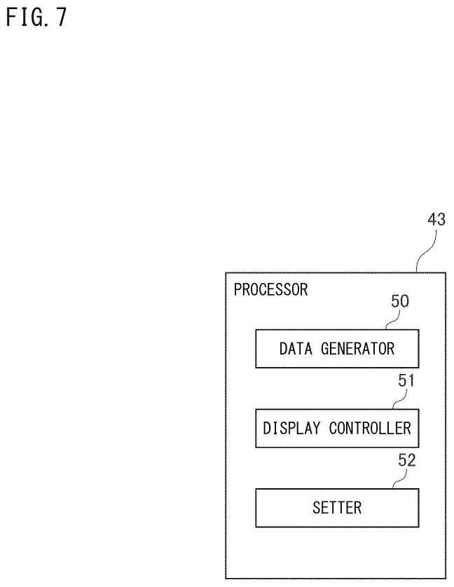

The functional units of the processor 43 of the present example embodiment will be described, with reference to FIG. 7. FIG. 7 is a functional block diagram of the processor 43 according to the present example embodiment. The processor 43 is configured or programmed to include a data generator 50, a display controller 51, and a setter 52. The data generator 50, the display controller 51, and the setter 52 are implemented by the processor 43 executing the above program stored in the memory storage 40.

The data generator 50 is configured or programmed to generate a three-dimensional shape model MD usable to machine a workpiece W on the basis of information including CAD data of the workpiece W. In the case where the bending operation includes multiple steps, the data generator 50 generates a shape model MD for each step on the basis of information including the CAD data of the workpiece W for each step. The shape model MD has, for example, a two-dimensional or three-dimensional shape model MS of the workpiece W for performing bending in the step corresponding to the shape model MD.

The display controller 51 is configured or programmed to cause the display 400 to display various types of information. The display controller 51 can cause the display 400 to display the shape model MD generated by the data generator 50 for each step. When causing the display 400 to display the shape model MD, the display controller 51 can freely change the display attribute of the shape model MD. For example, the display controller 51 can change the display angle of the shape model MD displayed on the display 400, as an example of the display attribute. For example, when the input interface 42 accepts a display attribute of the shape model MD, the display controller 51 changes the display angle of the shape model MD displayed on the display 400 to the display attribute accepted by the input interface 42.

For example, the input interface 42 accepting a display attribute of the shape model MD includes either or both of cases where the display attribute of the shape model MD, as shown on the display 400, is changed via a pointing device operation, or where the display attribute of the shape model MD is acquired through operations on a keyboard, voice input device, or similar. The display attribute is, for example, at least one of the display angle, the display magnification, of the transmittance of a shape model MD. The display angle of a shape model MD is synonymous with the viewpoint of the shape model MD.

The setter 52 is configured or programmed to set the display attribute of the shape model MD to display the shape model on the display of the press machine 100, to the display attribute accepted by the input interface 42. For example, in the case where a bending operation involves multiple steps, the setter 52 can, for each step, set the display attribute of the shape model MD to display the shape model on the display of the press machine 100. For example, the setter 52 is configured or programmed to set the display attribute of the shape model MD for each step by associating the shape model MD with its display attribute for each step and storing them in the memory storage 21. The data in which a shape model MD and its display attribute are associated may be referred to as “step assist data”. The setter 52 stores the step assist data for each step in the memory storage 21. When storing the display angle of a shape model MD in the memory storage 21, the setter 52 may store the display angle in the memory storage 21 as vector information. £ In such a case, the press machine 100 causes the display of the press machine 100 to display the display angle of the shape model MD in accordance with the vector information.

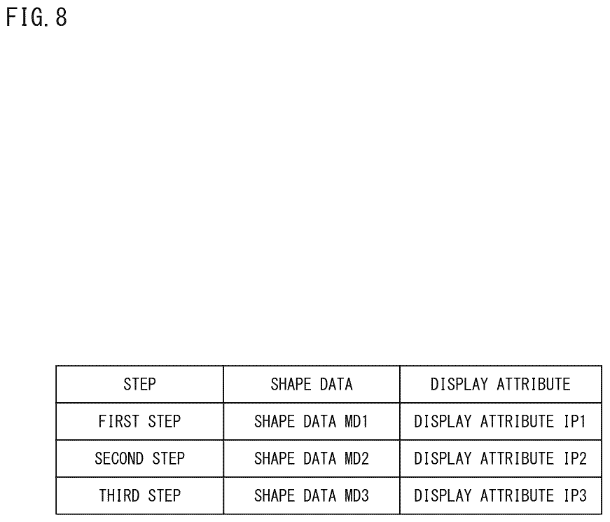

FIG. 8 is a diagram showing an example of step assist data. The step assist data exemplified in FIG. 8 is data for a case in which the bending operation includes three steps (a first step, a second step, and a third step). As shown in FIG. 8, for example, a shape model MD1 and the corresponding display attribute IP1 thereof are associated as step assist data for the first step. A shape model MD2 and the corresponding display attribute IP2 thereof are associated as step assist data for the second step. A shape model MD3 and the corresponding display attribute IP3 thereof are associated as step assist data for the third step. Two or more of the display attributes IP1, IP2, and IP3 may have mutually different values. In other words, the display attributes IP1, IP2, and IP3 do not all need to be set to the same value, and two or more of them can be set to different values.

The setter 52 can set the display attribute of the shape model MD. Therefore, for the second step different from the first step among the multiple steps, the setter 52 can set a display attribute to the corresponding shape model MD that differs from the display attribute of the shape model MD associated with the first step. It should be noted that setting the display attribute includes not only newly setting the display attribute but also changing the setting of the display attribute. For example, in the case where the display attribute for the shape model MD corresponding to the second step has already been set, if the input interface 42 receives a new input of the display attribute for the shape model MD in the second step, the setter 52 changes the setting of the display attribute of the step assist data in the second step to this newly input attribute.

An example of a method for setting the display attribute will be described below. A configurer SL is configured or programmed to operate the operation panel 44 to select a shape model MD for any given step from the shape models MD for the respective steps generated by the data generator 50, thus causing either a portion or an entirety of the selected shape model MD to be displayed on the display 400.

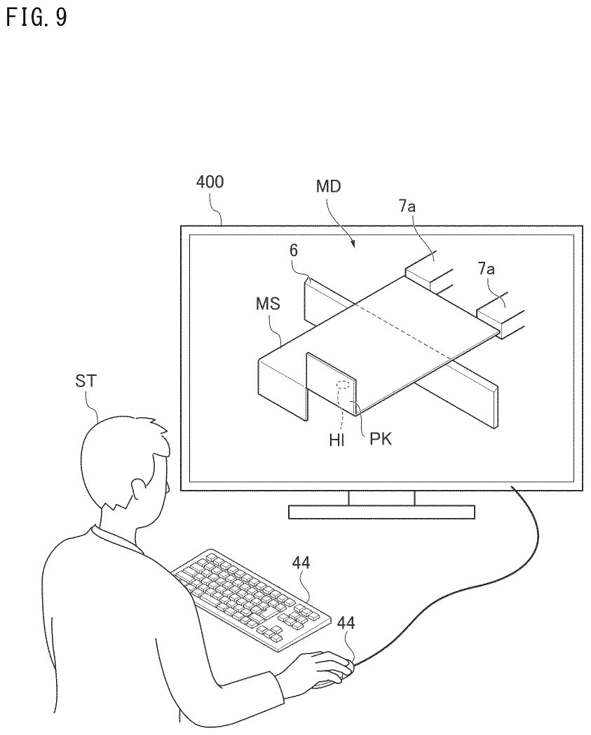

Next, the configurer SL operates the operation panel 44 (for example, by performing a drag operation) to change the display angle of the shape model MD displayed on the display 400 to an arbitrary angle. The term “arbitrary angle” refers, for example, to a display angle that allows the on-site operator OP to confirm the section that requires attention. FIG. 9 is a diagram showing an example of the shape model MD prior to a change in the display angle. In the example shown in FIG. 9, the shape model MD displayed on the display 400 includes a shape model of the lower die 6, a shape model of the back gauges 7a, and a shape model MS of the workpiece W that is in contact with the back gauges 7a in a preset orientation. In the example shown in FIG. 9, the section requiring the operator OP's attention is a hole HI formed in the workpiece W.

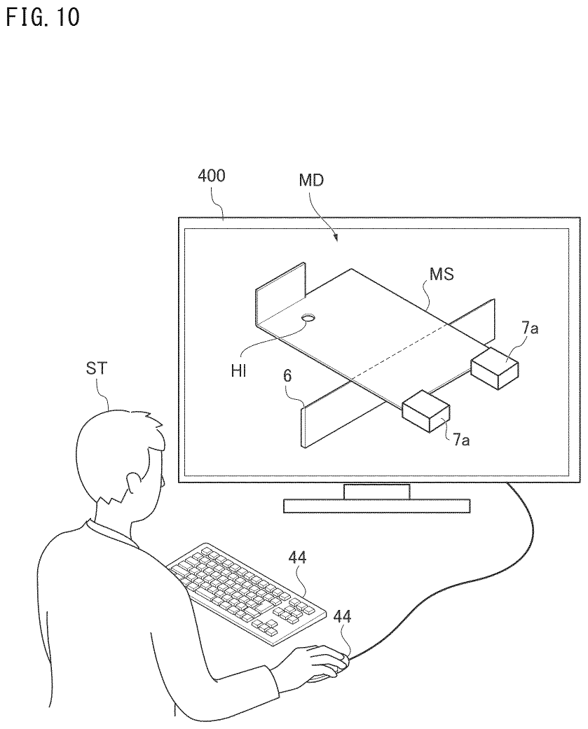

Here, at the display angle of the shape model MD shown in FIG. 9, the hole HI is obscured by a portion PK of the shape model MD and therefore cannot be confirmed. Therefore, even if the image G at the display angle shown in FIG. 9 is displayed on the display of the press machine 100, the operator OP cannot confirm the hole HI. In such a case, the configurer SL changes the display angle of the shape model MS displayed on the display 400 to a display angle at which the hole HI, as shown in FIG. 10, can be confirmed.

FIG. 10 is a diagram showing an example of the display angle of the shape model MD after the display angle shown in FIG. 9 is changed. The configurer SL operates the operation panel 44 (for example, by performing a drag operation) to rotate or move the shape model MD shown in FIG. 9, thus changing the display angle of the display 400 from the display angle shown in FIG. 9 to the display angle shown in FIG. 10. In other words, when the configurer SL operates the operation panel 44 and the input interface 42 accepts information on the display angle shown in FIG. 10, the display controller 51 changes the display of the display 400 from the display angle shown in FIG. 9 to the display angle shown in FIG. 10. In the case of displaying the image of the shape model MD at the display angle shown in FIG. 10 as the image G to be displayed on the display of the press machine 100 when the step selected above is performed by the press machine 100, the configurer SL performs a predetermined operation to save the display angle of the shape model MD after the change, that is, the display angle shown in FIG. 10. The predetermined operation is an operation for saving the changed display angle, and is, for example, an operation of pressing the icon of a save button displayed on the display 400.

When the predetermined operation described above is performed, the setter 52 stores the display angle of the shape model MD shown on the display 400, that is, the display angle shown in FIG. 10 and accepted by the input interface 42, in the memory storage 21 as a display attribute. As a result, the data of the shape model MD of the selected step and the display angle of the shape model MD displayed on the display 400 are associated with each other and stored in the memory storage 21 as step assist data. The parameter that configurer SL sets as an display attribute is not limited solely to display angle and may also include display magnification or the transmittance of the workpiece.

It is not necessary for the configurer SL to set the shape model MD for all the steps. For example, when the data generator 50 creates a shape model MD for each step, the setter 52 sets a first display attribute as the display attribute of the shape model MD for each step. In other words, the display attribute of the shape model MD of all the steps is set by the setter 52 to the first display attribute as default. In the case where the configurer SL intends to change the display attribute of the shape model MD of a certain step among the multiple steps, the configurer SL operates the operation panel 44 to change the display attribute of the shape model MD of the certain step from the first display attribute to the second display attribute.

For example, if there is a step in which an event may occur where the section requiring attention cannot be easily seen or is not visible in the shape model MD displayed on the display of the press machine 100 with the first display attribute (for example, a certain step), the configurer SL operates the operation panel 44 to input a second display attribute, different from the first display attribute, into the information processor 300. The configurer SL performs the predetermined operation described above to save the setting of the second display attribute. As a result, the setter 52 changes the display attribute of the shape model MD in the certain step, which is stored in the memory storage 21, from the first display attribute to the second display attribute.

The second display attribute may be a display angle at which the above section requiring attention can be confirmed. The second display attribute may be the transparency of the shape model MD. For example, if the section requiring attention is obscured because a portion of the shape model MS is arranged on the near side of the section requiring attention, the configurer SL may increase the transmittance of the part to a level that allows the section requiring attention to be seen through it. For example, in FIG. 9, the configurer SL increases the transmittance of the portion PK, and sets the transmittance to such an extent that the hole HI, which is the section requiring attention, can be seen through.

The second display attribute may be a display magnification. For example, if the section requiring attention mentioned above is difficult to see, the configurer SL may perform an operation to set the display magnification of the shape model MD in the certain step to a higher value, with the section part (for example, hole HI) serving as the center position, so that the section requiring attention is sufficiently visible. In the case where the display magnification is set as a display attribute, the information on the center position may be set at the same time.

Next, the display of the image G on the press machine 100 will be described specifically. The bending CAM data BD, which includes step assist data for each step and is stored in the memory storage 40, is sent to the press machine 100. For example, the information processor 300 may transmit the bending CAM data BD to the host device 200. For example, the configurer SL operates the operation panel 44 to cause the information processor 300 to transmit the bending CAM data BD including the step assist data for each step stored in the memory storage 40 to the host device 200. In such a case, the host device 200 receives the bending CAM data BD from the information processor 300 and transmits the received bending CAM data BD to the control device 4 of the press machine 100. However, the invention is not limited to this example, and the information processor 300 may directly transmit the bending CAM data BD to the control device 4 of the press machine 100. The bending CAM data BD is not limited to being transmitted from the information processor 300 or the host device 200. For example, the operator OP may connect a memory storage medium such as a USB memory storing bending CAM data BD to the control device 4 and import the bending CAM data BD into the control device 4.

As an example, before the operator OP begins a bending operation, electric power is supplied to the press machine 100. The press machine 100 then performs startup operations, such as origin return, and enters a ready (standby) state. The operator OP operates the operation panel 24 to input to the control device 4 an instruction to start operations. Upon detecting an input to start operations, the control device 4 requests the host device 200 for bending CAM data BD. The host device 200 transmits bending CAM data BD to the control device 4 in response to the request from the control device 4.

The control device 4 acquires the bending CAM data BD either transmitted from the host device 200 or stored in a memory storage medium and stores it in the memory storage 21. The control device 4 controls the projection of the image G corresponding to each step onto the projection area PA, on the basis of the step assist data included in the bending CAM data BD. For example, if the bending operation performed by the operator OP involves two steps, namely, a first step and a second step, the control device 4 first reads the step assist data corresponding to the first step and projects the shape model MD included in that data onto the projection area PA using the display attribute also contained in the same step assist data. For example, in the case where a display angle is set as a display attribute, the control device 4 projects an image G including the shape model MD seen from the display angle onto the projection area PA.

For example, in the case where a display magnification is set as a display attribute, the control device 4 projects an image G including the shape model MD of the first step onto the projection area PA at the display magnification set as a display attribute. For example, in the case where the transmittance of a portion of the shape model MD of the first step is set as a display attribute, the control device 4 projects onto the projection area PA an image G including the shape model MD reflecting that transmittance.

Upon executing the first step, the control device 4 reads the step assist data corresponding to the second step, as in the first step, and projects onto the projection area PA the shape model MD included in the step assist data with the display attribute included in the step assist data. In the case where the bending operation further includes a third step and a fourth step, the control device 4, as in the second step, projects an image G corresponding to the step assist data of the third step onto the projection area PA upon execution of the second step, and projects an image G corresponding to the step assist data of the fourth step onto the projection area PA upon execution of the third step.

Hereinafter, the operational effects according to the present example embodiment will be described. The operator OP performs bending of the workpiece W after confirming that the workpiece W is oriented in the predetermined direction when brought into contact with the back gauges 7a. However, for example, when bending a workpiece W with a shape that is nearly identical on the left and right sides, the operator OP may misidentify the orientation of the workpiece W and consequently bend it in the opposite direction, resulting in a machining defect. Therefore, the press machine 100 displays, for each step, an image on the display of the press machine 100 showing the orientation of the workpiece W to bring it into contact with the back gauges 7a, in order to prevent orientation errors by the operator OP.

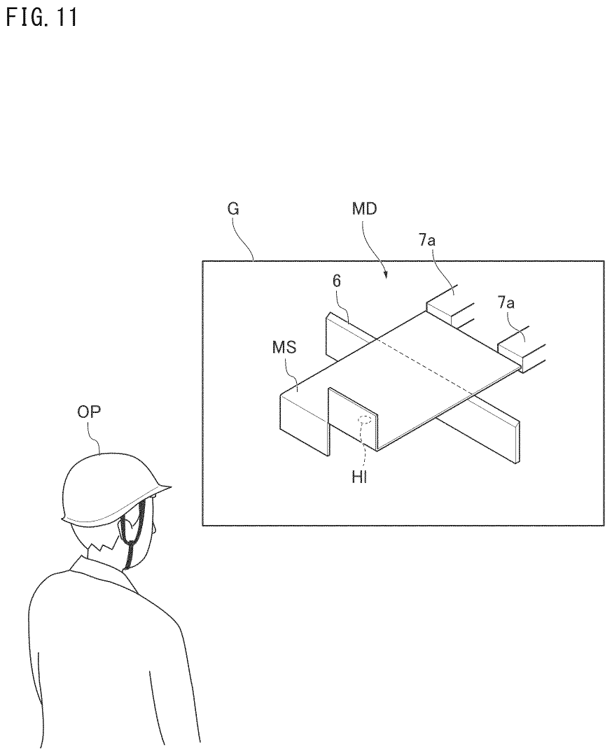

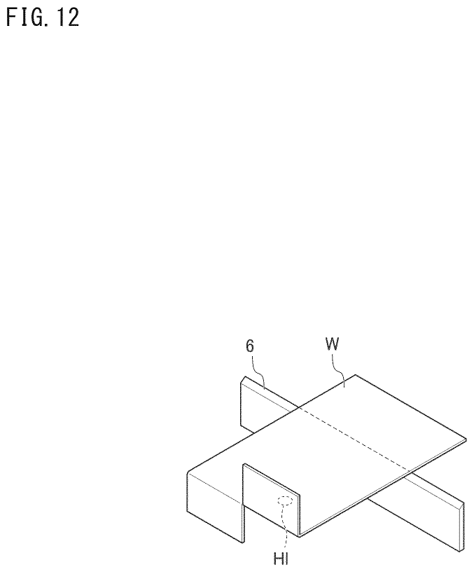

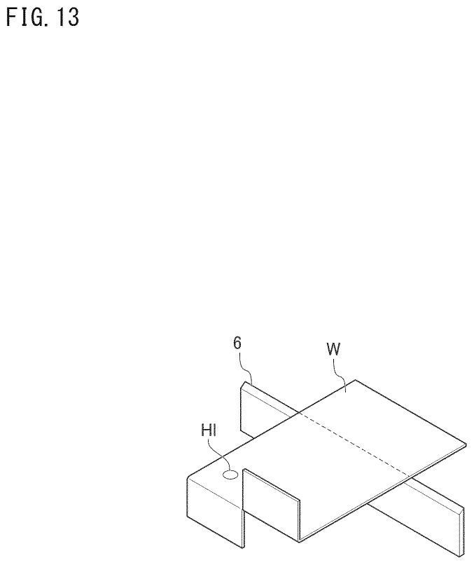

However, for example, in a certain step, even when the image displayed on the display of the press machine 100 is confirmed, the section requiring attention may still be difficult see and thus cannot be confirmed. More specifically, the display attribute for the model representing the workpiece W is set to a single value across all steps, regardless the step. For example, in an image including the shape model of a workpiece W in a state where the workpiece W is in contact with the back gauges 7a, the display angle of the shape model representing the workpiece W is set to only a certain display angle, regardless of the step. Therefore, even in a case where the above image is displayed on the display of the press machine 100, if this image is the image shown in FIG. 11, the operator OP will not be able to confirm the hole HI, which is the section requiring attention mentioned above. Consequently, even when viewing the image shown on the display of the press machine 100, the operator OP may overlook the hole HI and, as a result, may incorrectly arrange the workpiece as shown in FIG. 13, instead of the correct arrangement shown in FIG. 12. As a result, the operator OP may inadvertently bend the workpiece W in the opposite direction.

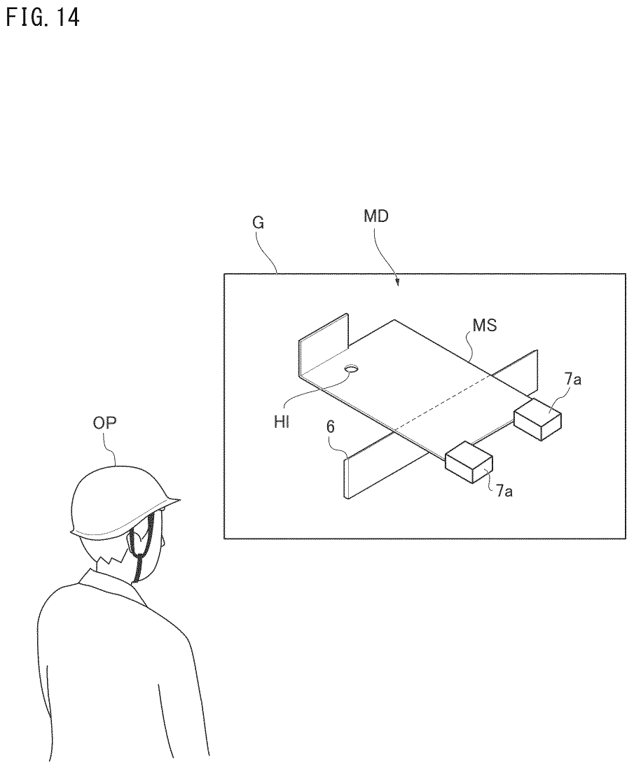

In order to prevent such machining defects, the operator OP typically needs to carefully observe the displayed image and identify the section requiring attention. However, this task is time-consuming and imposes a burden on the operator OP. To address this, the information processor 300 of the present example embodiment includes a configuration to set the display attribute of the shape model MD to display the shape model MD on the display of the press machine 100, to a display attribute accepted by the input interface 42. As a result, it is possible to set the display attribute, such as a display angle, of a shape model MD so as to make it easier to confirm the section that requires attention during the bending operation. Accordingly, the display of the press machine 100 can display the image G exemplified in FIG. 14, rather than the one in FIG. 11. As a result, when performing the bending operation, the operator OP can passively identify the section requiring attention (for example, hole HI) by simply confirming the image G shown in FIG. 14. As a result, it is possible to eliminate or reduce the task in which the operator OP identifies the section requiring attention while operating the operation panel 24, thus reducing the burden of the operator OP.

Example embodiments of the present disclosure may include the following configurations.

### Configuration 1

An information processor 300 is configured or programmed to create a shape model MD to display an image G to assist with an operator OP's operation on a display of a press machine 100 (for example, at least one of the projection area PA or the display 23) to machines a workpiece W. The information processor 300 is configured or programmed to include a data generator 50 configured or programmed to generate the shape model MD used in machining the workpiece W, an input interface 42 configured or programmed to accept input of a display attribute of the shape model MD, and a setter 52 configured or programmed to set the display attribute to display the shape model MD on the display to the display attribute accepted by the input interface 42.

### Configuration 2

The information processor 300 according to configuration 1, wherein the operation of the operator OP includes a plurality of steps, and the setter 52 is configured or programmed to set a different display attribute in each of the plurality of steps.

### Configuration 3

The information processor 300 according to configuration 1 or 2, wherein when the input interface 42 accepts the display attribute of a specific shape model MD, the setter 52 is configured or programmed to store in a memory storage 40 the specific shape model MD and the display attribute accepted by the input interface 42 in association with each other.

### Configuration 4

The information processor 300 according to any one of configurations 1 to 5, wherein the display attribute is at least one of a display angle, a display magnification, or a transmittance.

### Configuration 5

A press machine system RS includes the information processor 300 according to any one of configurations 1 to 4, and a press machine 100 to machine a workpiece W by clamping the workpiece W between an upper die and a lower die, wherein the press machine 100 includes a main body 2 to hold one of the upper die and the lower die, a display provided on the main body 2 or provided separately from the main body 2, and a control device 4 configured or programmed to display the shape model MD on the display using the display attribute set by the setter 52.

The example embodiments have been described above. However, the technical scope of the present invention is not limited to the description of the above example embodiments. It is also apparent to those skilled in the art that various modifications or improvements can be added to the above example embodiments. It is also apparent from the scope of claims that the present invention also encompasses one or more of such modifications or improvements. One or more of the requirements described in the above example embodiments may be omitted in some cases. One or more of the requirements described in the above example embodiments may be combined where appropriate. The order of executing procedures shown in the example embodiments can be implemented in an arbitrary order unless the result of the previous procedure is used in the following procedure. While operations in the above example embodiments have been described with expressions such as “first”, “next”, and “subsequently” for the sake of convenience, the operations need not always be implemented in that order.

The contents of Japanese Patent Application No. 2023-062828 and all documents cited in the detailed description of the present invention are incorporated herein by reference to the extent permitted by law.

While example embodiments of the present invention have been described above, it is to be understood that variations and modifications will be apparent to those skilled in the art without departing from the scope and spirit of the present invention. The scope of the present invention, therefore, is to be determined solely by the following claims.

1-6. (canceled)

7. An information processor to create a shape model to display an image to assist with an operator's operation on a display of a press machine to machine a workpiece, the information processor comprising:
a data generator configured or programmed to generate the shape model used in machining the workpiece;
an input interface configured or programmed to accept input of a display attribute of the shape model; and
a setter configured or programmed to set the display attribute of the shape model to display the shape model on the display to the display attribute accepted by the input interface.

8. The information processor according to claim 7, wherein
the operation includes a plurality of steps; and
the setter is configured or programmed to set a different display attribute in each of the plurality of steps.

9. The information processor according to claim 7, wherein when the input interface accepts the display attribute of a specific shape model, the setter is configured or programmed to store in a memory storage the specific shape model and the display attribute accepted by the input interface in association with each other.

10. The information processor according to claim 7, wherein the display attribute is at least one of a display angle, a display magnification, or a transmittance.

11. A press machine system comprising
the information processor according to claim 7; and
a press machine to machine a workpiece by clamping the workpiece between an upper die and a lower die; wherein
the press machine includes:
a main body to hold one of the upper die and the lower die;
a display provided on the main body or provided separately from the main body; and
a controller configured or programmed to display the shape model on the display using the display attribute set by the setter.

12. A data generation method of an information processor that creates a shape model to display an image to assist with an operator's operation on a display of a press machine that machines a workpiece, the data generation method comprising:
generating the shape model used in machining the workpiece;
accepting input of a display attribute of the shape model; and
setting the display attribute of the shape model to display the shape model on the display to the display attribute accepted by the input interface.
